(19) United States
(12) Patent Application Publication
(10) Pub. No.: US 2023/0091407 A1
(43) Pub. Date: Mar. 23, 2023

(54) TOUCH CONDUCTIVE FACEMASK FOR TOUCH SCREEN DEVICES

(71) Applicant: Jeffrey DAVIS, Winter Garden, FL (US)

(72) Inventor: Jeffrey DAVIS, Winter Garden, FL (US)

(21) Appl. No.: 17/950,259

(22) Filed: Sep. 22, 2022

Related U.S. Application Data
(60) Provisional application No. 63/247,012, filed on Sep. 22, 2021.

(51) Int. Cl. A41D 13/11; G06F 3/039

(52) U.S. Cl. CPC A41D 13/1107; G06F 3/0393

(57) ABSTRACT

A touch conductive facemask for touch screen devices includes a nonconductive facemask body comprising breathable material and having an inner surface facing a user when the facemask is worn and an outer surface facing away from the user. The facemask also includes a plurality of elastic straps coupled to the facemask body and configured to be placed around a head of the user. In addition, electrically conductive material such as conductive stitching or a conductive coating proximate a center portion of the facemask body passes from the inner surface to the outer surface of the facemask and is configured for bioelectricity from skin of the user that comes in contact with electrically conductive material on the inner surface to pass through to the outer surface to be sensed by a touch screen device.

### RELATED APPLICATION

This application claims priority to U.S. Provisional Application Ser. No. 63/247,012 filed on Sep. 22, 2021 the contents of which are herein incorporated by reference in their entirety.

### TECHNICAL FIELD

The present invention relates to the field of facemasks, and, more particularly, to a touch conductive facemask for touch screen devices.

### BACKGROUND

In areas with high numbers of COVID-19 cases, the CDC has recommended wearing a facemask in crowded outdoor settings and for activities with close contact with others who are not fully vaccinated. Wearing a facemask over your nose and mouth is often required on planes, buses, trains, and other forms of public transportation traveling into, within, or out of the United States and while indoors at U.S. transportation hubs such as airports and stations.

While the facemask provides protection from various airborne particulates, the facemask prevents persons with certain disabilities from being able to operate capacitive touchscreen devices with their faces because the facemask is not conductive. Gloves have been developed with conductive material for use with capacitive touchscreen devices, such as mobile phone touchscreens. One type of capacitive sensing device glove is made entirely from threads that are coated with a conductive material. Another type of capacitive sensing device glove includes a liner with an electrically conductive portion in a fingertip region of the glove that is electrically coupled with an electrically conductive portion of an outer shell of the glove. However, a disadvantage of the construction of the gloves is that they are not constructed to allow a person to breathe. Instead, the gloves are often thermal insulated and/or waterproof making the glove material and technology unsuitable for use as a mask.

Accordingly, what is needed in the art is an improved facemask that can be used by disabled persons to operate capacitive sensing devices.

### SUMMARY

A touch conductive facemask for touch screen devices is disclosed. The facemask includes a nonconductive facemask body comprising breathable material and having an inner surface facing a user when the facemask is worn and an outer surface facing away from the user. The facemask also includes a plurality of elastic straps coupled to the facemask body and configured to be placed around a head of the user. In addition, electrically conductive material such as conductive stitching or a conductive coating proximate a center portion of the facemask body passes from the inner surface to the outer surface of the facemask. The conductive material is configured for bioelectricity from skin of the user that comes in contact with the conductive material on the inner surface to pass through to the outer surface to be sensed by a touch screen device.

In another aspect, a touch conductive facemask kit for touch screen devices is disclosed. The kit includes a facemask body comprising breathable material and having an inner surface facing a user when the facemask is worn and an outer surface facing away from the user. In addition, a plurality of elastic straps are coupled to the facemask body and are configured to be placed around a head of the user. The kit also includes an electrically conductive coating. The electrically conductive coating is configured to be applied by a user proximate a center portion of the facemask body so that the conductive coating passes from the inner surface to the outer surface of the facemask body. Accordingly, bioelectricity from skin of the user that comes in contact with the electrically conductive coating on the inner surface passes through to the outer surface to be sensed by a touch screen device. The electrically conductive coating may be an electrically conductive paste or paint, for example.

In yet another aspect, a method of manufacturing a touch conductive facemask for touchscreen devices is disclosed. The method includes providing a facemask body comprising breathable material and having an inner surface facing a user when the facemask is worn and an outer surface facing away from the user. The method also includes applying an electrically conductive coating proximate a center portion of the facemask body that passes from the inner surface to the outer surface of the facemask body so that bioelectricity from skin of the user that comes in contact with the electrically conductive coating on the inner surface passes through to the outer surface to be sensed by a touch screen device.

### BRIEF DESCRIPTION OF THE DRAWINGS

FIG. 1 is a perspective view of a touch conductive facemask for touch screen devices in which various aspects of the disclosure may be implemented.

FIG. 2 is a rear view of the facemask of FIG. 1.

FIG. 3 is a rear view of another aspect of the facemask having a conductive coating.

FIG. 4 is a cross sectional view of the facemask taken in the direction of line 4-4 of FIG. 2.

FIG. 5 is a cross sectional view of the facemask taken in the direction of line 5-5 of FIG. 3.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

The invention as explained below can be used by persons with disabilities who rely on using their nose to operate capacitive touch screen devices such as computers, mobile phones, tablets, cameras, and kiosks, for example. Capacitive touchscreens use the electrical properties of the human body as input. When touched, a small electrical charge is drawn to the point of contact, which allows the display to detect where it has received an input. However, when the user who must use their nose to operate the touch screen device is wearing a fabric facemask, the capacitive touch screen cannot detect the point of contact because the existing facemask fabric material is not electrically conductive. Accordingly, the invention is directed to this shortcoming of existing facemasks so that the user can operate capacitive touch screen devices while wearing the facemask to limit the spread of certain respiratory diseases.

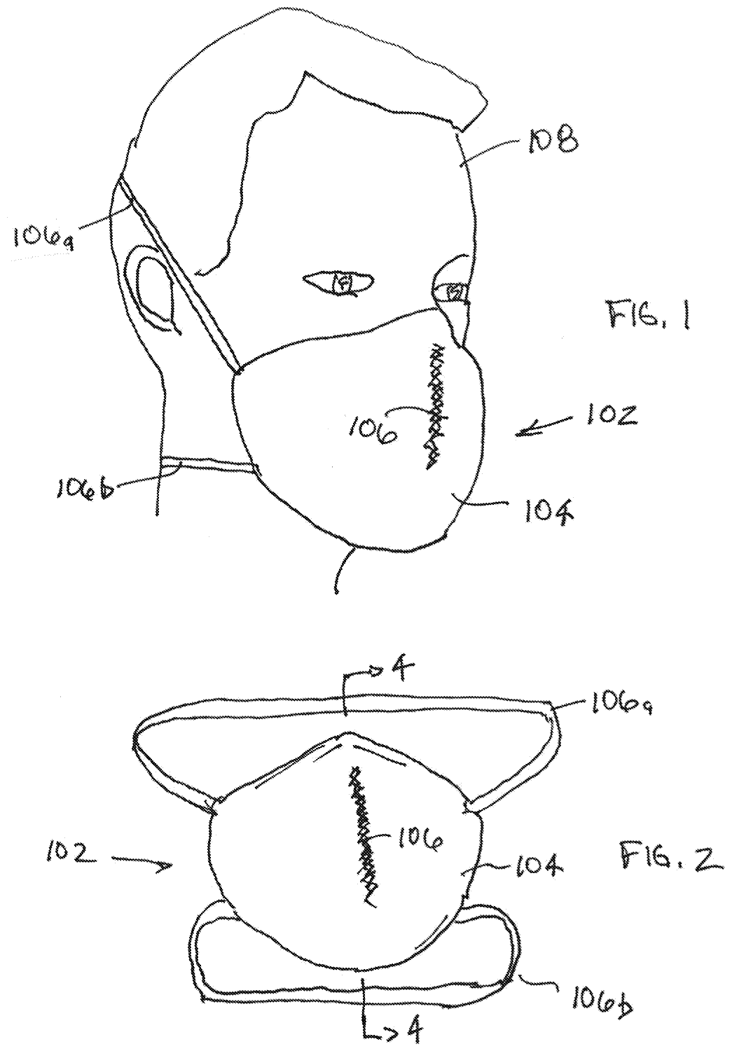

Referring now to FIG. 1, a touch conductive facemask for touch screen devices is generally designated 102. The facemask 102 includes a facemask body 104 comprising breathable material and having an inner surface facing a user 108 when the facemask 102 is worn and an outer surface facing away from the user 108. Breathable material is fabric that allows air to pass through it easily. In particular, so that the user can breathe normally when the material is placed over their nose and mouth and without affecting respiratory functions.

The facemask 102 also includes a plurality of elastic straps 106a, 106b coupled to the facemask body 104 and configured to be placed around a head of the user 108.

In addition, electrically conductive stitching 106 is positioned proximate a center portion of the facemask body 104 in the area of the nose of the user 108. As shown in FIG. 2, which is the inner surface of the facemask 102, the electrically conductive stitching 106 passes from the outer surface to the inner surface of the facemask body 104 and is configured for bioelectricity from skin of the user 108 that comes in contact with stitching 106 on the inner surface to pass through to the outer surface to be sensed by a touch screen device. Bioelectricity refers to electrical currents occurring within or produced by the human body. Increasing the amount of the electrically conductive stitching 106 increases the effectiveness of the facemask 102 when it is used with a capacitive touch screen device.

A stylus, a protrusion or other similar device in electrical communication with the stitching 106 could be secured to the facemask 102 in order to increase precision in using the facemask 102 by the user 108.

The facemask body 104 may comprise a nonconductive material or an electrically conductive material such as graphene. In addition, the center portion of the facemask body 104 may have a higher concentration of graphene than remaining areas of the facemask body 104. The flat, hexagonal lattice of graphene offers relatively little resistance to electrons carrying electricity and is conductive. Capacitive fabric, ribbon, thread, paint and paste can also be used with the facemask body 104.

The facemask 102 may comprise a N95 or KN95 type mask, or a costume mask, for example.

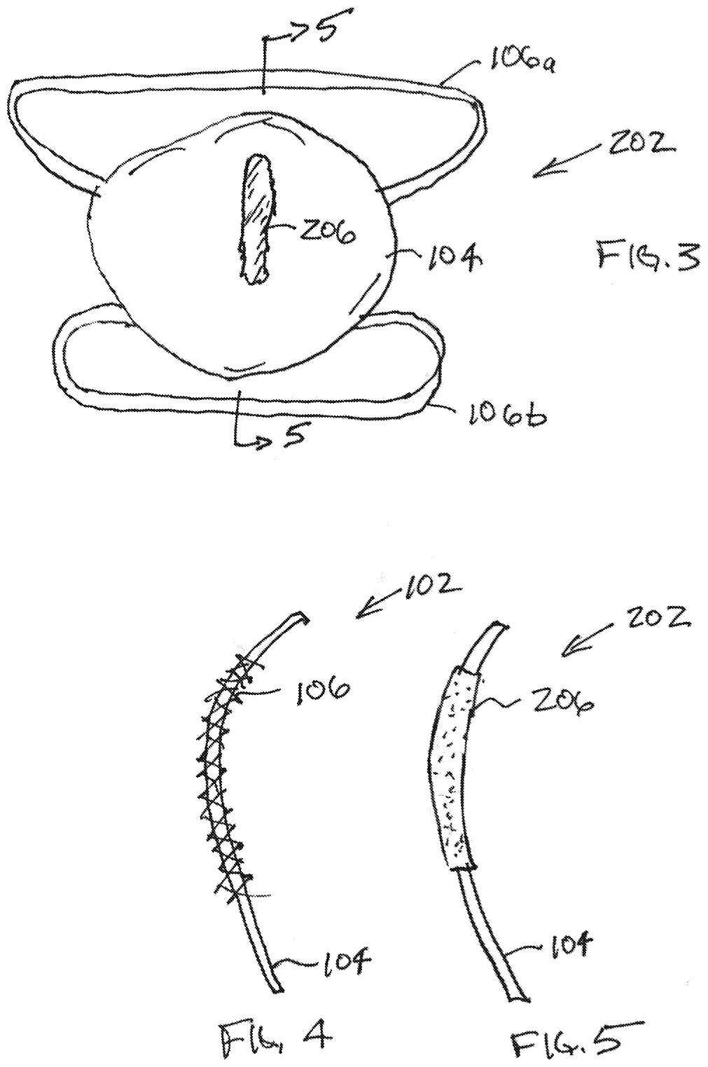

Another aspect of the facemask 202 is shown in FIG. 3. The facemask 202 includes conductive coating 206 that is integrated within the facemask body 104 as illustrated in FIG. 3 rather than conductive stitching. In addition, as those of ordinary skill in the art can appreciate, a conductive ribbon secured or integrated within the facemask 202 could be used or other similar type of conductive material and the invention is not limited to the examples provided herein.

The electrically conductive stitching is shown in cross sectional view in FIG. 4. As explained above, the stitching 106 passes all the way through the facemask body 104 so that the user is able to operate capacitive touch screen devices. The material of the facemask body 104 is important to be breathable fabric that enables the user to breathe normal when wearing the facemask 102. Similarly, the conductive coating 206 passes all the way through the facemask body 104 as illustrated in FIG. 5 in cross sectional view.

While the facemask 102 may be provided assembled as described above, the facemask can also be provided as a kit. For example, the kit may include a facemask body 104 and a supply of an electrically conductive coating 206. The electrically conductive coating 206 is configured to be applied by a user proximate a center portion of the facemask body 104 so that bioelectricity from skin of the user that comes in contact with the electrically conductive coating on the inner surface passes through to the outer surface to be sensed by a touch screen device.

Similar to that described above, the facemask body 104 may be a nonconductive material, or an electrically conductive material such as graphene. The facemask provided with the kit may be a N95 or KN95 type mask, or costume mask. The electrically conductive coating may be an electrically conductive paste or paint, for example. In addition, the supply of electrically conductive coating can also be applied to other clothing such as gloves or other parts of a costume.

A method of manufacturing a touch conductive facemask 102 for touchscreen devices includes providing a facemask body 104 comprising breathable material and where the facemask body 104 has an inner surface facing a user when the facemask 102 is worn and an outer surface facing away from the user. The method also includes applying the electrically conductive coating 206 proximate a center portion of the facemask body 104 so that the coating 206 passes from the inner surface to the outer surface of the facemask body 104 and as a result bioelectricity from skin of the user that comes in contact with the electrically conductive coating 206 on the inner surface passes through to the outer surface to be sensed by a touch screen device.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A touch conductive facemask for touch screen devices, the facemask comprising:
a facemask body comprising breathable material and having an inner surface facing a user when the facemask is worn and an outer surface facing away from the user;
a plurality of straps coupled to the facemask body and configured to be placed around a head of the user; and
electrically conductive material proximate a center portion of the facemask body configured to be sensed by a touch screen device.

2. The touch conductive facemask of claim 1, wherein the facemask body comprises a nonconductive material.

3. The touch conductive facemask of claim 1, wherein the facemask body comprises a conductive material.

4. The touch conductive facemask of claim 3, wherein the conductive material of the facemask body comprises graphene.

5. The touch conductive facemask of claim 4, wherein the center portion of the facemask body having a higher concentration of graphene than remaining areas of the facemask body.

6. The touch conductive mask of claim 1, wherein the facemask comprises a N95 or KN95 type mask.

7. The touch conductive facemask of claim 1, wherein the electrically conductive material comprises electrically conductive stitching passing from the inner surface to the outer surface of the facemask body and configured for bioelectricity from skin of the user that comes in contact with stitching on the inner surface to pass through to the outer surface to be sensed by the touch screen device.

8. The touch conductive facemask of claim 1, wherein the electrically conductive material comprises electrically conductive coating proximate a center portion of the facemask body and passing from the inner surface to the outer surface of the facemask body and configured for bioelectricity from skin of the user that comes in contact with the coating on the inner surface to pass through to the outer surface to be sensed by a touch screen device.

9. The touch conductive facemask of claim 8, wherein the electrically conductive coating comprises an electrically conductive paste or paint.

10. The touch conductive facemask of claim 1, wherein the facemask comprises a costume mask.

11. A touch conductive facemask kit for touch screen devices, the facemask kit comprising:
a facemask body comprising breathable material and having an inner surface facing a user when the facemask is worn and an outer surface facing away from the user;
a plurality of straps coupled to the facemask body and configured to be placed around a head of the user; and
electrically conductive coating, wherein the electrically conductive coating is configured to be applied by a user proximate a center portion of the facemask body and passing from the inner surface to the outer surface of the facemask body so that bioelectricity from skin of the user that comes in contact with the electrically conductive coating on the inner surface passes through to the outer surface to be sensed by a touch screen device.

12. The touch conductive facemask kit of claim 11, wherein the facemask body comprises a nonconductive material.

13. The touch conductive facemask kit of claim 11, wherein the facemask body comprises an electrically conductive material.

14. The touch conductive mask kit of claim 13, wherein the electrically conductive material comprises graphene.

15. The touch conductive mask kit of claim 11, wherein the facemask comprises a N95 or KN95 type mask.

16. The touch conductive facemask kit of claim 11, wherein the electrically conductive coating comprises an electrically conductive paste or paint.

17. The touch conductive facemask kit of claim 11, wherein the facemask comprises a costume mask.

18. A method of manufacturing a touch conductive facemask for touchscreen devices, the method comprising:
providing a facemask body comprising breathable material and having an inner surface facing a user when the facemask is worn and an outer surface facing away from the user; and
applying an electrically conductive coating proximate a center portion of the facemask body and passing from the inner surface to the outer surface of the facemask body so that bioelectricity from skin of the user that comes in contact with the electrically conductive coating on the inner surface passes through to the outer surface to be sensed by a touch screen device.

19. The method of claim 18, wherein the facemask body comprises an electrically conductive material of graphene.

20. The method of claim 19, wherein the electrically conductive coating comprises an electrically conductive paste or paint.
